(19) United States
(12) Patent Application Publication
(10) Pub. No.: US 2017/0015874 A1
(43) Pub. Date: Jan. 19, 2017

(54) Flame-retarded foam adhesive tape

(71) Applicant: TESA SE, Norderstedt (DE)

(72) Inventors: Werner KLUGE-PALETTA, Buchholz (DE); Karsten SEITZ, Buxtehude (DE); Weibin CHEN, Suzhou Industrail Park (CN); Qin Lu, Jiangsu (CN); Lily Wang, Jiangsu Province (CN)

(73) Assignee: TESA SE, Norderstedt (DE)

(21) Appl. No.: 15/207,976

(22) Filed: Jul. 12, 2016

(30) Foreign Application Priority Data
Jul. 16, 2015 (CN) 201510654203.7

(51) Int. Cl. C09J 7/02; B32B 27/32; B32B 5/18; B32B 7/12; C09K 21/12; C09J 11/06

(52) U.S. Cl. CPC C09J 7/0289; C09K 21/12; C09J 11/06; B32B 5/18; B32B 7/12; B32B 27/32; C09J 133/06

(57) ABSTRACT

Foamed pressure-sensitive adhesive tape having outstanding flame retardancy values and also very good technical adhesive properties comprising a foamed layer and an outer pressure sensitive adhesive layer wherein the outer pressure sensitive adhesive layer comprises at least 10 wt % of flame retardant and the foamed layer comprises less than 10 wt % of flame retardant or none, based in each case on the total weight of the layer in question.

The present invention is situated within the technical field of pressure sensitive adhesive tapes, more particularly that of flame-retarded pressure-sensitive adhesive tapes, and relates specifically to a flame-retarded foam adhesive tape.

### BACKGROUND OF THE INVENTION

There are a host of applications and constructions where materials used are subjected by the legislator to exacting requirements in terms of their low flammability. Adhesives and adhesive tapes of low flammability are therefore employed in particular in constructions which are subject to such elevated safety requirements. Such constructions are found in sectors including that of transport, in aircraft, trains, and buses, for example, and also elevators. In buildings as well, especially those accessible to the public, a frequent requirement is to equip adhesive tapes used therein in such a way that they are of low flammability or are totally nonflammable. Another example is computer technology, where progressive miniaturization of components is increasingly dictating use of pressure sensitive adhesive tapes, at the same time as the requirements of those tapes are becoming ever greater. Very high temperatures may occur in the circuits simply in operation. Where soldered connections are produced on the circuits as well, temperatures of 280° C. or more occur, and adhesive tapes present must not ignite at such temperatures.

The concepts of “flame retardancy” and “low flammability” frequently also encompass indirect aspects such as reduced smoking and reduced evolution of heat, and also prevention or at least reduction of the formation of harmful gases.

Foamed pressure sensitive adhesive tapes are used diversely in temporary or permanent bonds. Usually they are used as adhesive assembly tapes, in order to join two substrates or components to one another. This presupposes double-sided coating of the adhesive tape with pressure sensitive adhesive. In addition there are also single-sided foamed pressure sensitive adhesive tapes.

Generally speaking, foamed pressure sensitive adhesive tapes—whether of single-sided or double-sided design—are increasingly being preferred on account of the mechanical properties, which are adjustable across a wide range. The adjustability of the profile of properties is attributable substantially to the design of the foam. Particularly advantageous properties can be achieved using foamed adhesive tapes in particular in relation to the damping behavior.

Flame-retarded adhesives and sealants based on adhesive or thermoplastic polymers and salts of phosphinic acid are described for example in EP 1 975 217 A2.

DE 10 2012 210 386 A1 describes an adhesive tape for protecting edges of glass, which comprises a hard phase and a soft phase comprising a polymer foam, the hard phase and soft phase having a particular ratio of thickness to one another.

Subject matter of WO 2009/052335 A1 includes adhesive tapes which comprise a carrier and an adhesive composition, with the carrier and/or the adhesive composition able to comprise a halogen-free flame retardant composition. Said composition in turn comprises phosphinate or phosphinate salt and optionally other nonhalogenated flame retardants such as aluminum trihydrate or magnesium hydroxide.

US 2007/0059521 A1 describes a flame-retarded pressure-sensitive acrylate adhesive tape which comprises a layer of pressure sensitive adhesive comprising a flame retardant and composed of an acrylate polymer, and a second layer of pressure sensitive adhesive, comprising an acrylate polymer. The second layer of pressure sensitive adhesive is located at least partly on both sides of the first layer of pressure sensitive adhesive, that comprising the flame retardant, and this first layer of pressure sensitive adhesive is a foam.

There is an ongoing demand for flame-retarded, foamed pressure sensitive adhesive tapes with an extremely broadly adjustable profile of properties. An object of the present invention was to provide adhesive tapes of this kind having outstanding flame retardancy values and also very good technical adhesive properties.

The invention is based on the concept of carrying out special placement of the flame retardant in the construction of the adhesive tape.

### SUMMARY OF THE INVENTION

A first subject of the invention is an adhesive tape which comprises a foamed layer and an outer layer of pressure sensitive adhesive and wherein the outer layer of pressure sensitive adhesive comprises at least 10 wt % of flame retardant and the foamed layer contains less than 10 wt % of flame retardant or none, based in each case on the total weight of the layer in question. With an adhesive tape construction of this kind, the foam, which is responsible for the predominant part of the profile of properties, is kept very largely free from adverse effects due to the flame retardant. Accordingly, a series of parameters can be adjusted across a broad range, and all in all a high level of technical adhesive and mechanical properties can be achieved. All of this is obtained not at the expense of the flame retardancy performance; instead, this requirement as well is outstandingly met.

### DETAILED DESCRIPTION

An “adhesive tape” is understood generally to be a system which is extended substantially in two directions in space and which can therefore be referred to as a sheetlike structure, this system having, at least on one of its two outwardly facing principal surfaces, a pressure sensitive adhesive or a (re)activatable adhesive and being therefore able, at least after activation, to develop adhesive activity. The term “adhesive tape” also covers systems which are already in bonded form, but whose basic state is covered by the definition above. Not covered by the term “adhesive tape” are liquid adhesives, not even in the fully cured and/or bonded state.

The adhesive tape of the invention comprises a foamed layer. The expression “foamed” means that the layer comprises formations of gas-filled, spherical or polyhedral cells which are bounded by liquid, semiliquid, relatively high-viscosity or solid cell struts, and which are present in the layer in question in a proportion such that the density of the foamed layer is reduced relative to the density of the matrix material, in other words the entirety of the nongaseous materials of which the layer in question is composed. In accordance with the invention, the density of the foamed layer is preferably 30 to 700 kg/m³, more preferably 50 to 500 kg/m³, more particularly 50 to 200 kg/m³.

The thickness of the foamed layer is preferably 300 μm to 6000 μm, more preferably 800 μm to 5000 μm, more particularly 1000 μm to 4500 μm.

The foamed layer is preferably a layer of a polymer foam. This is a foam whose matrix material is formed substantially of one or more polymers. The matrix material of the foamed layer comprises one or more polymers preferably to an extent of at least 30 wt %, more preferably at least 50 wt %, and very preferably at least 70 wt %, more particularly at least 90 wt %, based in each case on the total weight of the foamed layer. The polymers of the polymer foam are preferably selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; polyacrylates and also mixtures of two or more of the aforementioned polymers. The matrix material of the foamed layer therefore comprises preferably to an extent of least 30 wt %, more preferably to an extent of at least 50 wt %, and very preferably to an extent of at least 70 wt %, more particularly at least 90 wt %, based in each case on the total weight of the foamed layer, one or more polymers selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; polyacrylates and also mixtures of two or more of the aforementioned polymers. With particular preference the foamed layer comprises no polymers other than one or more polymers selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; polyacrylates and also mixtures of two or more of the aforementioned polymers.

With particular preference the polymer foam and/or the foamed layer comprises at least one polymer selected from polyolefins and copolymers of ethylene and an ethylene substituted by a polar group. In particular, the fraction of all polymers selected from polyolefins and copolymers of ethylene and an ethylene substituted by a polar group in the foamed layer is at least 30 wt %, more preferably at least 50 wt %, and very preferably at least 70 wt %, more particularly at least 80 wt %, as for example at least 90 wt %, based in each case on the total weight of the foamed layer. Very preferably the foamed layer contains no polymers other than one or more polymers selected from polyolefins and copolymers of ethylene and an ethylene substituted by a polar group.

A “polyolefin” in accordance with the invention refers to a polymer of the general structure—[CH₂—CR¹R²-]ₙ—, in which R¹ and R² independently of one another are a hydrogen atom or a linear or branched, saturated, aliphatic or cycloaliphatic group. The polyolefin is preferably polyethylene, polypropylene, an ethylene-propylene copolymer, or a mixture of polyethylene and polypropylene. This polyethylene may comprise one or more of the types of polyethylene known per se, such as HDPE, LDPE, LLDPE, VLDPE, VLLDPE, blends of these types of polyethylene, and mixtures thereof. The polypropylene is preferably a crystalline polypropylene, more preferably a homopolypropylene (hPP). In one specific embodiment of the invention the foamed layer contains no other polymers besides one or more polyolefins.

A copolymer of ethylene and an ethylene substituted by a polar group refers to a polymer of the general structure —[CH₂—CR³R⁴-]ₙ—, in which R³ or R⁴ is a hydrogen atom and the remaining substituent in each case is a group comprising at least one oxygen atom. The copolymer of ethylene and an ethylene substituted by a polar group is preferably an ethylene-vinyl acetate copolymer (EVA), an ethylene-methyl acrylate copolymer (EMA), an ethylene-ethyl acrylate copolymer (EEA), an ethylene-acrylic acid copolymer (EAA), an ethylene-butyl acrylate copolymer (EBA), or a mixture of these. More preferably the copolymer of ethylene and an ethylene substituted by a polar group is an ethylene-vinyl acetate copolymer (EVA). The EVA preferably has a vinyl acetate content of 3 to 70 wt %, more preferably of 5 to 30 wt %, more particularly of 10 to 20 wt %. In one specific embodiment of the invention the foamed layer contains no polymers other than one or more copolymers of ethylene and an ethylene substituted by a polar group, and more particularly contains no further polymers apart from an ethylene-vinyl acetate copolymer (EVA).

The foaming of the matrix material may in principle have been brought about in any customary way, as for example by an added blowing gas or by a chemical foaming agent which decomposes during processing at a defined temperature and, in so doing, forms gas.

PE foams are frequently produced by mixing the customarily pulverulent foaming agent and the polymer in a first step. This mixture constitutes what is called the masterbatch. Then, in the next step, the other components of the foam are mixed in, examples being residual polymers, ageing inhibitors, optionally flame retardants, etc. For this purpose it is possible to use extruders, such as twin-screw extruders, for example, or kneading apparatus.

In a further process step, the mixture is then extruded to form a foamed matrix, in a single-screw extruder, for example, and this matrix is discharged as a layer through a die. The result is what is called a film bale. The composition is subsequently crosslinked, by means for example of electron beam curing by means of an electron beam accelerator.

Then, in a final step, foaming takes place, frequently in the form of thermal foaming, i.e., foaming initiated by thermal activation of the foaming agent.

In accordance with the invention the foamed layer contains no flame retardant or, if it does contain flame retardant, then it contains less than 10 wt % of flame retardant. It has emerged that with levels of flame retardant of this kind, there is no adverse effect, or virtually none, on the properties of the foamed layer. The properties of the foamed layer, which may also be viewed as the carrier layer of the adhesive tape, have a substantial influence on the performance of the adhesive tape. In accordance with the invention, therefore, the lower the proportions of flame retardant in the foamed layer, the more preferable they are. The foamed layer preferably contains less than 8 wt % of flame retardant or none, more preferably less than 6 wt % or none, more particularly less than 3 wt % or none, as for example less than 1 wt % or none.

With very particular preference the foamed layer is free from flame retardants. “Free from” in this context does not necessarily mean “free from” in the strict mathematical sense, but should be interpreted to mean “free from flame retardants added deliberately”. Amounts of flame retardant in the range of the universal concentration, or amounts resulting in a technically unavoidable way from the production of the foamed layer, are considered immaterial by the invention in relation to the feature “free from flame retardant”.

The adhesive tape of the invention comprises an outer layer of pressure sensitive adhesive. The term “outer layer of pressure sensitive adhesive” is understood to mean that the layer of pressure sensitive adhesive in question is able to develop an adhesive effect outwardly, in other words an adhesive effect directed to a substrate not belonging to the adhesive tape. A prerequisite for this is that the layer is not covered on its outside by a further layer. In accordance with the invention, however, a release liner of the kind commonly used to protect the adhesive surfaces of an adhesive tape is not considered a constituent of the adhesive tapes. This means that the “outer layer of pressure sensitive adhesive” is designated as such even when it is lined with a release liner.

A pressure sensitive adhesive is understood in this specification, as is customary within the general usage, as a material which—in particular at room temperature—is permanently tacky and also adhesive. Characteristics of a pressure sensitive adhesive are that it can be applied by pressure to a substrate and remains adhering there, with no further definition of the pressure to be applied or the period of exposure to this pressure. In certain cases, depending on the precise nature of the pressure sensitive adhesive, the temperature, and the atmospheric humidity and also the substrate, a minimal pressure of short duration, which does not go beyond gentle contact for a brief moment, is enough to achieve the adhesion effect, while in other cases a longer-term period of exposure to a high pressure may be necessary.

Pressure sensitive adhesives have particular, characteristic viscoelastic properties which result in the permanent tack and adhesiveness.

A characteristic of these adhesives is that when they are mechanically deformed, there are processes of viscous flow and there is also development of elastic forces of resilience. The two processes have a certain relationship to one another in terms of their respective proportion, in dependence not only on the precise composition, the structure, and the degree of crosslinking of the pressure sensitive adhesive under consideration, but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also in a high peel strength. Highly crosslinked systems, crystalline polymers, or polymers with glasslike solidification lack flowable components and are therefore in general devoid of tack or possess only little tack at least.

The proportional elastic forces of resilience are necessary for the attainment of cohesion. They are brought about, for example, by very long-chain macromolecules with a high degree of coiling, and also by physically or chemically crosslinked macromolecules, and they allow the transmission of the forces that act on an adhesive bond. As a result of these forces of resilience, an adhesive bond is able to withstand a long-term load acting on it, in the form of a long-term shearing load, for example, sufficiently over a relatively long time period.

For the more precise description and quantification of the extent of elastic and viscous components, and also of the relationship between the components, it is possible to employ the variables of storage modulus (G′) and loss modulus (G″), which can be determined by means of Dynamic Mechanical Analysis (DMA). G′ is a measure of the elastic component, G″ a measure of the viscous component, of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation is measured relative to the introduction of the shearing stress. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/γ)·sin(δ) (τ=shear stress, γ=deformation, δ=phase angle=phase shift between shear stress vector and deformation vector).

A substance is considered in general to be a pressure sensitive adhesive, and is defined as being pressure-sensitively adhesive for the purposes of this specification, if at room temperature, presently by definition 23° C., in the deformation frequency range from 10⁰ to 10¹ rad/sec, G′ is located at least partly in the range from 10³ to 10⁷ Pa and if G″ likewise is located at least partly within this range. “Partly” means that at least one section of the G′ curve lies within the window described by the deformation frequency range from 10° inclusive up to 10¹ inclusive rad/sec (abscissa) and by the G′ value range from 10³ inclusive up to 10⁷ inclusive Pa (ordinate), and if at least one section of the G″ curve is likewise located within this window.

The adhesive tape of the invention comprises an outer layer of pressure sensitive adhesive, and thus comprises at least one outer layer of pressure sensitive adhesive. In accordance with the invention it is possible for the adhesive tape to contain an outer layer of pressure sensitive adhesive on its second side as well and hence to be a double-sided adhesive tape. In that case preferably both outer layers of pressure sensitive adhesive are in accordance with the invention, thus comprising in particular at least 10 wt % of flame retardant. The second outer layer of pressure sensitive adhesive may be identical to the first, or else alternatively may differ from the first. It is also possible in accordance with the invention for the adhesive tape to have two outer layers of pressure sensitive adhesive, but for only one of the two layers to be an outer layer of pressure sensitive adhesive of the invention, thus containing in particular at least 10 wt % of flame retardant.

The outer layer of pressure sensitive adhesive preferably comprises at least one polymer selected from the group consisting of poly(meth)acrylates, natural rubber, synthetic rubbers, silicones, polyurethanes and mixtures of two or more of the above-recited polymers. With particular preference the outer layer of pressure sensitive adhesive comprises at least one poly(meth)acrylate. More particularly the outer layer of pressure sensitive adhesive contains no polymers other than one or more poly(meth)acrylates.

“Poly(meth)acrylates” are understood, in line with the general understanding, to be polymers obtainable by radical polymerization of acrylic and/or methylacrylic monomers and also, optionally, further copolymerizable monomers. The term “poly(meth)acrylate” in accordance with the invention encompasses not only polymers based on acrylic acid and derivatives thereof but also polymers based on acrylic acid and methacrylic acid and derivatives thereof and polymers based on methacrylic acid and derivatives thereof, the polymers always including acrylic esters, methacrylic esters, or mixtures of acrylic and methacrylic esters. The poly(meth)acrylates of the outer layer of pressure sensitive adhesive preferably have an average molar mass M_{w} of not more than 2 000 000 g/mol.

The monomers of the poly(meth)acrylates of the outer layer of pressure sensitive adhesive and their quantitative composition are preferably selected such that the so-called Fox equation (E1)

$$\frac{1}{{T}_{g}} = {\sum }_{n} \frac{{W}_{n}}{{T}_{g , n}} \qquad ( E1 )$$

(cf. T. G. Fox, Bull. Am. Phys. Soc. 1 (1956) 123) produces a T_{g} for the polymer of ≦25° C. A value of this kind is particularly advantageous for pressure sensitive adhesives which are employed substantially at room temperature.

In equation E1, n represents the serial number of the monomers used, wₙ the mass fraction of the respective monomer n (wt %) and T_{g,n} the respective glass transition temperature of the homopolymer of the respective monomer n, in kelvins.

The outer layer of pressure sensitive adhesive preferably comprises one or more poly(meth)acrylates which can be traced back to the following monomer composition:
a) Acrylic esters and/or methacrylic esters of the formula (F1)

CH₂=C(R^{I})(COOR^{II}) (F1),
in which R^{I}=H or CH₃ and R^{II} is an alkyl radical having 1 to 30 C atoms, more preferably 4 to 14 C atoms, very preferably 4 to 9 C atoms;
b) olefinically unsaturated monomers having functional groups which exhibit reactivity with crosslinker substances;
c) optionally further olefinically unsaturated monomers, which are copolymerizable with the monomers (a) and (b).

Examples of monomers a) are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as, for example, isobutyl acrylate, 2-ethylhexyl acrylate, 2-ethylhexyl methacrylate, isooctyl acrylate, isooctyl methacrylate. With particular preference, R^{II} is a methyl, a n-butyl, and a 2-ethylhexyl group, more particularly a n-butyl and a 2-ethylhexyl group, or the monomers a) are selected from n-butyl acrylate and 2-ethylhexyl acrylate.

The monomers b) are preferably olefinically unsaturated monomers having functional groups which are able to enter into a reaction with epoxide groups. More preferably the monomers b) each contain at least one functional group selected from the group consisting of hydroxyl, carboxyl, sulfonic acid and phosphonic acid groups, acid anhydride functions, epoxide groups, and substituted or unsubstituted amino groups.

In particular the monomers b) are selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, 2-hydroxyethyl acrylate, 3-hydroxypropyl acrylate, 2-hydroxyethyl methacrylate, 3-hydroxypropyl methacrylate, 6-hydroxyhexyl methacrylate, allyl alcohol, glycidyl acrylate and glycidyl methacrylate. Very preferably the monomers b) are acrylic acid and/or methacrylic acid, especially acrylic acid.

Contemplated as monomers c) in principle are all vinylically functionalized compounds which are copolymerizable with the monomers a) and with the monomers b). Through selection and amount of the monomers c) it is possible advantageously to regulate properties of the pressure sensitive adhesive of the invention.

The monomers c) are more preferably selected from the group consisting of methyl acrylate, ethyl acrylate, n-propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, 2-butoxyethyl methacrylate, 2-butoxyethyl acrylate, 3,3,5-trimethylcyclohexyl acrylate, 3,5-di methyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexa-fluoroisopropyl acrylate, 1,1,1,3,3,3-hexafluoroisopropyl methacrylate, 2,2,3,3,3-pentafluoro-propyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropyl-methacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, N,N-dialkyl-substituted amides, more particularly N,N-dimethylacrylamide, N, N-dimethylmethacrylamide, N-benzylacrylamide, N-isopropylacrylamide, N-tert-butylacrylamide, N-tert-octylacrylamide, N-methylolacrylamide, N-methylolmethacrylamide; additionally acrylonitrile, methacrylonitrile; vinyl ethers such as vinyl methyl ether, ethyl vinyl ether, vinyl isobutyl ether; vinyl esters such as vinyl acetate; vinyl chloride, vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-di methoxystyrene, 2-polystyrene-ethyl methacrylate (molecular weight Mw of 4000 to 13 000 g/mol) and poly(methyl methacrylate)-ethyl methacrylate (Mw of 2000 to 8000 g/mol). In particular the monomer c) is methyl acrylate.

The monomers c) may advantageously also be selected such that they contain functional groups which support radiation-chemical crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

With particular preference, where the outer layer of pressure sensitive adhesive comprises a plurality of poly(meth)acrylates, all poly(meth)acrylates in the outer layer of pressure sensitive adhesive can be traced back to the above-described monomer composition. More particularly all poly(meth)acrylates in the outer layer of pressure sensitive adhesive can be traced back to a monomer composition of acrylic acid, n-butyl acrylate, 2-ethylhexyl acrylate and methyl acrylate.

With very particular preference, the poly(meth)acrylate and/or all poly(meth)acrylates in the outer layer of pressure sensitive adhesive can be traced back to the following monomer composition:

| | |
|---|---|
| acrylic acid | 1-10 wt % |
| methyl acrylate | 1-15 wt % |
| 2-ethylhexyl acrylate | 30-60 wt %, |
| n-butyl acrylate | 25-50 wt %, |

the proportions of the monomers adding up to 100 wt %.

The poly(meth)acrylates can be prepared by radical polymerization of the monomers in solvents, more particularly in solvents having a boiling range of 50 to 150° C., preferably of 60 to 120° C., using the customary amounts of polymerization initiators, which are in general 0.01 to 5, more particularly 0.1 to 2 wt % (based on the total weight of the monomers).

Suitable in principle are all customary initiators familiar to the skilled person. Examples of radical sources are peroxides, hydroperoxides and azo compounds, as for example dibenzoyl peroxide, cumene hydroperoxide, cyclohexanone peroxide, di-tert-butyl peroxide, cyclohexylsulphonyl acetyl peroxide, diisopropyl percarbonate, tert-butyl peroctoate, benzopinacol. One very preferred procedure uses 2,2′-azobis(2-methylbutyronitrile) or 2,2′-azobis(2-methylpropionitrile) (2,2′-azobisisobutyronitrile; AIBN) as radical initiator.

Solvents contemplated for preparing the poly(meth)acrylates include alcohols such as methanol, ethanol, n-propanol and isopropanol, n-butanol and isobutanol, preferably isopropanol and/or isobutanol, and also hydrocarbons such as toluene and, in particular, benzines from a boiling range of 60 to 120° C. Additionally it is possible to use ketones such as preferably acetone, methyl ethyl ketone, methyl isobutyl ketone, and esters such as ethyl acetate, and also mixtures of solvents of the type stated, preference being given to mixtures which include isopropanol, more particularly in amounts of 0.5 to 15 wt %, preferably 3 to 10 wt %, based on the solvent mixture used.

Within the outer layer of pressure sensitive adhesive, the proportion of the entirety of polymers selected from the group consisting of poly(meth)acrylates, natural rubber, synthetic rubbers, silicones, polyurethanes, and mixtures of two or more of the polymers recited above is preferably 35 to 90 wt %, more preferably 40 to 75 wt %, more particularly 45 to 68 wt %, very preferably 50 to 62 wt %, as for example 52 to 60 wt %, based in each case on the total weight of the outer layer of pressure sensitive adhesive. More preferably the fraction within the outer layer of pressure sensitive adhesive of the entirety of poly(meth)acrylates is 35 to 90 wt %, more preferably 40 to 75 wt %, more particularly 45 to 68 wt %, very preferably 50 to 62 wt %, as for example 52 to 60 wt %, based in each case on the total weight of the outer layer of pressure sensitive adhesive.

In accordance with the invention the outer layer of pressure sensitive adhesive contains at least 10 wt % of flame retardant. Preferably the outer layer of pressure sensitive adhesive contains 10 to 35 wt % of flame retardant, more preferably 12 to 30 wt % of flame retardant, more particularly 14 to 28 wt % of flame retardant, as for example 17 to 26 wt % of flame retardant, based in each case on the total weight of the outer layer of pressure sensitive adhesive. Provision is therefore made in accordance with the invention for the flame retardancy properties of the adhesive tape to be determined substantially, preferably completely, by the flame retardant present in the outer layer of pressure sensitive adhesive and/or in the outer layers of pressure sensitive adhesive. It has been found that in order for sufficient flame retardancy properties to be achieved, it is enough for the outer layer or layers of pressure sensitive adhesive to be provided with flame retardant. An advantage possible as a result is that the foamed layer is kept largely or completely free from any influencing by added flame retardant. Many properties, particularly mechanical properties, of the adhesive tape are manifested fully in this way and are not lessened in their extent by flame retardancy-related additions.

The foamed layer preferably contains less than 8 wt %, more preferably less than 6 wt %, more particularly less than 3 wt %, as for example less than 1 wt %, very preferably no flame retardant, and the outer layer of pressure sensitive adhesive contains 10 to 35 wt % of flame retardant, more preferably 12 to 30 wt % of flame retardant, more particularly 14 to 28 wt % of flame retardant, as for example 17 to 26 wt % of flame retardant, based in each case on the total weight of the layer in question.

Flame retardants which can be used in the adhesive tape of the invention include for example aluminum oxide hydrates, zinc borates, ammonium phosphates and/or ammonium polyphosphates, antimony oxide, chlorinated paraffins, polychlorinated biphenyls, hexabromobenzene, polybrominated diphenyl ethers; cyanurates such as melamine cyanurates; organic phosphoric acid derivatives, as for example 2-carboxyethyl-phenylphosphoric acid; organic phosphates and polyphosphates, phosphites and phosphonates, as for example tritolyl phosphate, tert-butylphenyl diphenyl phosphate, bisphenol A bis(diphenylphosphate), resorcinol bis(diphenylphosphate), and melamin polyphosphate, diethyl bis(2-hydroxyethyl)aminomethylphosphonate and diphenylanilinophosphonate; phosphinic salts, diphosphinic salts, and dialkylphosphinic salts; and also halogenated organic phosphorus compounds such as tris(2,3-dibrompropyl) phosphate, tris(2-bromo-4-methylphenyl) phosphate, and tris(2-chloroisopropyl) phosphate. Halogen-free flame retardants are preferred in accordance with the invention. The flame retardants which can be used in the invention are therefore preferably selected from the group consisting of aluminum oxide hydrates, zinc borates, ammonium phosphates and ammonium polyphosphates, antimony oxide; cyanurates; organic phosphoric acid derivates; organic phosphates, phosphites, and phosphonates; phosphinic salts, diphosphinic salts, and dialkylphosphinic salts, and also mixtures of two or more of the above-recited flame retardants. With particular preference the flame retardants which can be used in accordance with the invention are selected from the group consisting of ammonium polyphosphates and dialkylphosphinic salts.

Dialkylphosphinic salts preferred in accordance with the invention are those of the formula F2

(R^{III}R^{IV}(O)P—O⁽⁻⁾)ₘM^{(M+′)} (F2),

in which R^{III} and R^{IV} are identical or different and are a linear or branched C₁- to C₆ alkyl radical;
M is Mg, Ca, Al, Sb, Sn, Ge, Ti, Fe, Zr, Zn, Ce, Bi, Sr, Mn, Li, Na, K, or a pronated nitrogen base; and
m is a natural number from 1 to 4.

M is preferably Al, Ca, Ti, Zn, Sn or Zr.

R^{III} and R^{IV} are preferably identical or different and are a methyl, ethyl, n-propyl, isopropyl, n-butyl, isobutyl, tert-butyl, n-pentyl, isopentyl, n-hexyl or isohexyl radical.

Particularly preferred dialkylphosphinic salts are aluminum trisdiethylphosphinate, aluminum trismethylethylphosphinate, aluminum trisethylbutylphosphinate, titanyl bisdiethylphosphinate, titanium tetrakisdiethylphosphinate, titanyl bismethylethylphosphinate, titanium tetrakismethylethylphosphinate, titanyl bisethylbutylphosphinate, titanium tetrakisethylbutylphosphinate, zinc bisdiethylphosphinate, zinc bismethylethylphosphinate and zinc bisethylbutylphosphinate, and also mixtures of one or more of these dialkylphosphinic salts.

The outer layer of pressure sensitive adhesive preferably comprises at least one flame retardant selected from the group consisting of ammonium polyphosphates and dialkylphosphinic salts. More preferably the outer layer of pressure sensitive adhesive contains no further flame retardants other than one or more flame retardants selected from the group consisting of ammonium polyphosphates and dialkylphosphinic salts.

In particular the flame retardant comprises aluminum trisdiethylphosphinate. In one specific embodiment the outer layer of pressure sensitive adhesive contains no flame retardants other than aluminum trisdiethylphosphinate. In a further embodiment the adhesive tape of the invention includes no further flame retardants other than aluminum trisdiethylphosphinate.

The flame retardant, in addition to the substances already mentioned, may in accordance with the invention encompass one or more compounds known as synergists. Synergists may be present in the flame retardant at 0.1 to 70 wt %, based on the total weight of the flame retardant. With particular preference the flame retardant comprises

a) 60 to 99 wt % of one or more compounds selected from dialkylphosphinic salts of the formula F2 and ammonium polyphosphates, and
b) 1 to 40 wt % of one or more synergists,
the proportions being based on the total weight of the flame retardant and adding up to 100 wt %.

The synergists are preferably nitrogen, phosphorous or phosphorous-nitrogen compounds. More preferably the synergist or synergists is or are selected from the group consisting of allantoin, cyanuric acid, glycoluril, urea, melamine, melam, melem, melon, melamine phosphate, melamine pyrophosphate, melamine polyphosphate, melam polyphosphate, melem polyphosphate, melon polyphosphate, melamine cyanurate, piperazine phosphate, piperazine pyrophosphate, carbodiimide, sterically hindered phenols, phosphine oxide, hypophosphite, cyclic phosphonates, triaryl (alkyl) phosphites, alkyl- and aryl-substituted phosphates, aluminum, tin, boron, magnesium, calcium and cerium compounds, zinc oxide, zinc carbonate, zinc stannate, zinc borate, zinc hydrogenphosphate, zinc pyrophosphate, zinc oleate, zinc stearate and/or zinc phosphate.

Where the flame retardant comprises one or more synergists, they are regarded in accordance with the invention as part of the flame retardant. If present, therefore, they are included in particular as well in the proportions—mentioned in the preceding sections—of the flame retardant within the outer layer of pressure sensitive adhesive or within the foamed layer.

The flame retardant can be incorporated into the compositions of the outer layer of pressure sensitive adhesive and, where appropriate, of the foamed layer using customary mixing apparatus, such as with agitator mechanisms, for example. Incorporation takes place preferably before the layer in question is applied.

Besides one or more polymers and one or more flame retardants, the outer pressure sensitive adhesive may comprise other constituents, examples being ageing inhibitors, plasticizers, crosslinkers and/or promoters. These substances are also referred to collectively below as “auxiliaries”.

In one embodiment of the invention, the outer layer of pressure sensitive adhesive contains at least one tackifying resin which is selected from the group consisting of pinene resins, indene resins and rosins and also their disproportionated, hydrogenated, polymerized, esterified derivatives and salts; aliphatic and aromatic hydrocarbon resins, terpene resins, terpene-phenolic resins, and also mixtures of two or more of the above-listed tackifying resins. Among the hydrocarbon resins, it is possible to use all those compatible with (soluble in) the poly(meth)acrylate in question, reference being made more particularly to all aliphatic, aromatic and alkylaromatic hydrocarbon resins, hydrocarbon resins based on pure monomers, hydrogenated hydrocarbon resins, functional hydrocarbon resins and also natural resins, especially to C₅ to C₉ hydrocarbon resins. With particular preference the outer layer of pressure sensitive adhesive comprises at least one tackifying resin selected from terpene-phenolic resins and C₅-C₉ hydrocarbon resins. In particular the outer layer of pressure sensitive adhesive comprises a terpene-phenolic resin.

The outer layer of pressure sensitive adhesive preferably comprises 5 to 45 wt %, more preferably 10 to 38 wt %, more particularly 13 to 35 wt %, very preferably 15 to 30 wt % of tackifying resin(s).

In one embodiment of the invention the outer layer of pressure sensitive adhesive contains

| | |
|---|---|
| 40 to 75 wt % | of poly(meth)acrylate, |
| 10 to 38 wt % | of tackifying resin, |
| 10 to 35 wt % | of flame retardant, and |
| 0 to 5 wt % | of auxiliaries, |

the weight fractions adding up to 100 wt %.

More particularly the outer layer of pressure sensitive adhesive contains

| | |
|---|---|
| 45 to 68 wt % | of polymethacrylate having the follower monomer |
| | composition: |

| | |
|---|---|
| acrylic acid | 1-10 wt % |
| methyl acrylate | 1-15 wt % |
| 2-ethylhexyl acrylate | 30-60 wt %, |
| n-butyl acrylate | 25-50 wt %, |

| | |
|---|---|
| | the fractions of the monomers adding up to 100 wt %; |
| 13 to 35 wt % | of terpene-phenolic resin; |
| 12 to 30 wt % | of flame retardant; and |
| 0 to 5 wt % | of auxiliaries. |

Flame retardants, resins and other adjuvants can be incorporated into the pressure sensitive adhesive by mixing these substances into the polymer dispersion. In that case the polymer or polymers may advantageously be crosslinked thermally after the adhesive has been applied, using aluminum chelates such as aluminum acetylacetonate, for example. In this way, the solvent can be stripped off and the polymer crosslinked in one step. Suitable amounts of crosslinker are approximately 0.2 to 0.4 wt %, based on the mass of the polymer.

Another alternative possibility is to incorporate flame retardants, resins and auxiliaries into the polymer which has already been freed from the solvent. For this purpose it is possible to use kneaders, extruders and similar apparatus. The polymer can then be crosslinked thermally, or else by electron beam crosslinking. Also conceivable are crosslinking processes where both variants are employed.

In principle the incorporation of flame retardants into a pressure sensitive adhesive is more difficult than their incorporation into the foam, since the foam is generally processed mechanically in any case. In the low-viscosity adhesives, there is a risk of phenomena such as agglomeration, adverse effects on the crosslinking reaction and/or on the coating pattern, formation of surface structures, reduction in the adhesion of the pressure sensitive adhesive to the foam carrier, or a fall in moisture resistance. For these and other reasons, the flame retardants have to date been incorporated preferably into the foamed carrier. In the context of the present invention, however, it emerged that the flame retardants can also easily be incorporated into the pressure sensitive adhesives, with no adverse effect, or at worst no substantial effect, on the technical adhesive performance capacity of the adhesive tapes.

The ratio of the basis weights of outer layer of pressure sensitive adhesive, or of the total basis weight of both outer layers of pressure sensitive adhesive, to foamed layer is preferably ≧3:10, more preferably ≧1:2. With ratios of this kind, particularly good flame retardancy properties are achieved. It is evident from the above that, if the adhesive tape has an outer layer of pressure sensitive adhesive of the invention on each side, the basis weight is understood to be the sum of the basis weights of both outer layers of pressure sensitive adhesive. The basis weight of the foamed layer may be adjusted in principle by means of any desired combination of layer thickness and foam density.

The adhesive tape of the invention may include further layers of the kind customary in adhesive tape construction, examples being primer layers, barrier layers, getter layers, reinforcing layers, etc.

The layer construction of the adhesive tape of the invention may be produced in principle by all technologies contemplated, as for example by coating, laminating or lining. The adhesion between the individual layers may be improved by subjecting individual surfaces or both surfaces of the foamed layer, and/or the surface of the outer layer of pressure sensitive adhesive that is facing the foamed layer, to corona treatment or plasma treatment or to flaming. It is likewise possible for a primer to be applied between foamed layer and outer layer of pressure sensitive adhesive, and also, where appropriate, between these and other layers.

The outer layer of pressure sensitive adhesive may be lined with a release liner, intended to protect it from accretion of dust and other contaminants from the environment. All liners systems known per se are contemplated. Liners are used to line a layer of pressure sensitive adhesive up until the time of its bonding in the application scenario; a liner, then, is an auxiliary agent which must be disposed of after having been removed from the layer of pressure sensitive adhesive. The same applies for a release film, which represents a special case of a liner insofar as the release coating has been applied to a film. Generally and also in the context of the present invention, a liner is not considered part of the adhesive tape, but instead is considered merely as an auxiliary agent.

Liners in general are release papers (papers with a silicone coating on one or both sides) or release films (frequently polyester films, polypropylene films or polyethylene films with a silicone coating). In accordance with the invention, however, other release systems and/or release coatings are also contemplated.

Adhesive tapes of the invention can be used, for example, in the interior equipping of buildings and means of transport, particularly of course for constructions which are subject to heightened fire prevention requirements. They can be employed, for example, for fixing signs and similar elements to components, especially metallic components, in buses, and for fixing metallic construction elements for reinforcement (“reinforcement bars”) of panels in elevators, or of reinforcing elements in boats. Examples of other areas of application are in bonding of mirrors, of impact protection strips on hospital beds, or else of noise protection mats on the inner wall of aircraft, in which case the latter are frequently fixed by way of touch-and-close strips used additionally. A further subject of the invention is therefore the use of an adhesive tape of the invention for the fixing, more particularly for the permanent adhesive bonding, of components in the interior equipping of buildings and/or vehicles.

### Examples

A variety of single-sided or double-sided foam adhesive tapes were produced. Foam formulations used were as follows:

PE and EVA foams: Alveolit series, from Sekusui Alveo AG
PU foam: PU slabstock foam, from Mayser
PP/PE foam: produced as per EP 1 752 485 A1.

The pressure sensitive adhesive was produced as follows:

A 2 L glass reactor conventional for radical polymerizations was charged with 12 g of acrylic acid, 20 g of methyl acrylate, 174 g of n-butyl acrylate, 194 g of 2-ethylhexyl acrylate, and 300 g of acetone/isopropanol (99:1). After nitrogen gas had been passed through the reactor for 45 minutes with stirring, the reactor was heated to 58° C. and 0.2 g of 2,2′-azobisisobutyronitrile (AIBN, Vazo 64®, from DuPont) was added. Then the external heating bath was heated to 75° C. and the reaction was carried out constantly at this external temperature. After a reaction time of 1 h a further 0.2 g of Vazo 64 was added. After 3 h and again after 6 h, 150 g each time of an acetone/isopropanol mixture (99/1) was added for dilution. In order to reduce the residual initiators, portions of 0.4 g of di-(4-tert-butylcyclohexyl) peroxydicarbonate (Perkadox 16®, from Akzo Nobel) were added after 8 h and after 10 h. After a reaction time of 22 h, the reaction was discontinued and cooling took place to room temperature.

The determination of the molecular weight according to test A gave an M_{w}=1 100 000 g/mol with a polydispersisty M_{w}/Mₙ=7.3.

The adhesive was then freed from solvent under reduced pressure and with heating, and was blended in a kneader with 30 wt % (based on the polymer) of terpene-phenolic resin and with the particular envisaged amount of aluminum diethylphosphinate.

The resulting composition was coated as a hotmelt through a die onto a siliconized release paper (from Laufenberg) (coat weight 50 g/m²). This was followed by lining onto the respective foamed carrier (see table 1). The pressure sensitive adhesives were crosslinked with 60 kGy and 200 kV EB.

In this way, various adhesive tapes having the parameters in table 1 were produced, and were subjected to a DIN 75200 burn rate test. In this test, the horizontal adhesive tape, with a strip width of 19 mm and clamped in a U-shaped mounting frame, is subjected to the action of a defined flame, with moderate flame exposure over 15 seconds on the open end of the adhesive. A determination is made of whether and, if so, when the flame goes out or of the time at which the flame front traverses a burning section located between two measurement marks. The test is passed as long as a maximum burning rate of 102 mm/min is not exceeded. In the best case the flame goes out before the first measurement mark is reached (i.e. self-extinguishing).

The results are contained in table 1. The worst and best results were determined in each case as the average value from three experiments.

TABLE 1
Adhesive tape constructions and results

| | Carrier | | Basis weight ratio | Pass scored | |
|---|---|---|---|---|---|
| | (density, | pressure | pressure | in DIN 75200 | Worst/best |
| | thickness, FR | sensitive | sensitive | test | result |
| No. | content) | adhesive | adhesive/Carrier | yes/no | (mm/min) |
| 1 | PE foam | double-sided, | 1:1 | no | 191.3/173.9 |
| (CE) | (67 kg/m³, 1.5 mm) | without FSM | | | |
| | with 5 wt | | | | |
| | % FR | | | | |
| 2 | PE foam | double-sided, | 1:1 | yes | se/se |
| | (67 kg/m³, 1.5 mm) | with 20 wt % FR | | | |
| | without | | | | |
| | FR | | | | |
| 3 | PE foam | double-sided, | 2:3 | yes | 42.5/se |
| | (50 kg/m³, 3 mm) | with 20 wt % FR | | | |
| | without | | | | |
| | FR | | | | |
| 4 | PE foam | double-sided, | 5:6 | yes | se/se |
| | (40 kg/m³, 3 mm) | with 20 wt % FR | | | |
| | without | | | | |
| | FR | | | | |
| 5 | PE foam | double-sided, | 10:9 | yes | se/se |
| | (30 kg/m³, 3 mm) | with 20 wt % FR | | | |
| | without | | | | |
| | FR | | | | |
| 6 | PE foam | double-sided, | 1:2 | yes | 40.0/se |
| | (50 kg/m³, 4 mm) | with 20 wt % FR | | | |
| | without | | | | |
| | FR | | | | |
| 7 | EVA foam | double-sided, | 1:4 | no | 156.5/130.8 |
| (CE) | (200 kg/m³, | with 20 wt % FR | | | |
| | 2 mm) without | | | | |
| | FR | | | | |
| 8 | PE foam | double-sided, in | 4:3 | yes | se/se |
| | (50 kg/m³, 3 mm) | each case | | | |
| | without | 100 g/m^{2.}; with | | | |
| | FR | 20 wt % FR | | | |
| 9 | EVA foam | double-sided, in | 1:2 | yes | se/se |
| | (200 kg/m³, | each case | | | |
| | 2 mm) without | 100 g/m²; with | | | |
| | FR | 20 wt % FR | | | |
| 11 | PU foam | double-sided, | 1:3 | yes | se/se |
| | (430 kg/m³, | with 20 wt % FR | | | |
| | 0.8 mm) | | | | |
| | without FR | | | | |
| 12 | PP/PE (50/50) | double-sided, | 3:2 | yes | se/se |
| | foam | with 20 wt % FR | | | |
| | (67 kg/m³, | | | | |
| | 1 mm) without | | | | |
| | FR | | | | |

CE = comparative example
se = self-extinguishing
FR = flame retardant

The adhesive tapes of examples 2 and 12 were additionally subjected to technical adhesive investigations. Test methods used in this case were as follows:

90° peel strength to steel—open and lined sides

The peel strength on steel was determined under test conditions of 23° C. +/−1° C. temperature and 50% +/−5% relative humidity. The specimens were cut to a width of 20 mm and adhered to a steel plate. Prior to the measurement, the steel plate was cleaned and conditioned. For that purpose the plate was first wiped down with acetone and then left to stand in the air for 5 minutes to allow the solvent to evaporate.

The side of the layered assembly facing away from the test substrate was then lined with a 50 μm aluminum foil, to prevent the specimen stretching during measurement. Thereafter the test specimen was rolled onto the steel substrate. For this purpose the tape was rolled over five times back and forth with a 2 kg roller, at a rolling rate of 10 m/min. Immediately after roller application, the steel plate was inserted into a special mount, which allows the specimen to be peeled off vertically upward at an angle of 90° C. The peel strength was measured using a Zwick tensile testing machine.

The results of measurement are reported in N/cm and have been averaged from three measurements.

### Holding Power

Specimens were prepared under test conditions of 23° C. +/−1° C. temperature and 50% +/−5% relative humidity. The test specimens were cut to 13 mm and adhered to a steel plate. The bond area was 20 mm×13 mm (length×width). Prior to the measurement, the steel plate was cleaned and conditioned. For this purpose the plate was first wiped down with acetone and then left to stand in the air for 5 minutes to allow the solvent to evaporate. After bonding, the open side was reinforced with a 50 μm aluminum foil, and rolled over twice back and forth with a 2 kg roller. Subsequently a belt loop was attached at the protruding end of the layered assembly. The whole assembly was then suspended from a suitable apparatus and loaded with 10 N. The suspension apparatus is such that the weight loads the sample at an angle of 179+/−1°. This ensured that the three-layer assembly was unable to peel off from the bottom edge of the plate. The holding power measured, being the time between suspending and falling of the specimen, is reported in minutes and corresponds to the average from three measurements. For the measurement of the lined side, the open side was first reinforced with the 50 μm aluminum foil, the release material was removed, and the assembly was adhered to the test plate in analogy with the description. The measurement was carried out under standard conditions (23° C., 55% humidity).

### Dynamic Shear Strength

The adhesive tape under investigation was cut square to an edge length of 25 mm, bonded overlappingly between two steel plates, and pressed down for one minute with a force of 0.9 kN (force P). After storage for 24 hours at 23° C. and 50% relative humidity, the assembly was parted, in a tensile testing machine from the company ZWICK, at 50 mm/min at 23° C. and 50% relative humidity, in such a way that the two steel plates were pulled apart at an angle of 180°. A determination was made of the maximum force in N/cm².

The results are set out in table 2.

TABLE 2
technical adhesive tests

| Example 2 | | Example 12 | |
|---|---|---|---|
| | without | | without |
| with FR | FR | with FR | FR |

Peel strength on steel (ASTM) [N/cm]

| | | | | | |
|---|---|---|---|---|---|
| Immediately | open side | 19.8 | 19.4 | 15.2 | 19.2 |
| | lined side | 19.3 | 21.1 | 13.0 | 13.9 |
| After 14 d | open side | 23.1 | 23.0 | 19.6 | 20.9 |
| | lined side | 18.0 | 19.8 | 19.0 | 20.0 |

Shear test [min]

| | | | | | |
|---|---|---|---|---|---|
| 10 N RT | open side | 597 | 994 | 272 | 497 |
| | lined side | 610 | 1040 | 536 | 594 |

Dynamic shear test [N/cm²]

| | | | | |
|---|---|---|---|---|
| Immediately | 47.6 | 47.3 | 64.7 | 62.3 |

All of the values satisfy customary requirements imposed on foamed adhesive tapes particularly in connection with the interior equipping of buildings and means of transport.

1. An adhesive tape comprising a foamed layer and an outer layer of pressure sensitive adhesive, wherein the outer layer of pressure sensitive adhesive comprises at least 10 wt % of flame retardant and the foamed layer comprises less than 10 wt % of flame retardant or none, based in each case on the total weight of the layer in question.

2. The adhesive tape as claimed in claim 1, wherein the outer layer of pressure sensitive adhesive comprises up to 35 wt % of flame retardant, based on the total weight of the outer layer of pressure sensitive adhesive.

3. The adhesive tape as claimed in claim 1, wherein the outer layer of pressure sensitive adhesive comprises at least 15 wt % of flame retardant, based on the total weight of the outer layer of pressure sensitive adhesive.

4. The adhesive tape as claimed in claim 1, wherein the basis weight ratio of the sum of the outer layers of pressure sensitive adhesive to the foamed layer is ≧3:10.

5. The adhesive tape as claimed in claim 1, wherein the foamed layer comprises at least one polymer selected from the group consisting of polyolefins and copolymers of ethylene and an ethylene substituted by a polar group.

6. The adhesive tape as claimed in claim 1, wherein the outer layer of pressure sensitive adhesive comprises at least one poly(meth)acrylate.

7. The adhesive tape as claimed in claim 1, wherein the outer layer of pressure sensitive adhesive comprises at least one tackifying resin.
